(19) United States
(12) Patent Application Publication
(10) Pub. No.: US 2005/0071605 A1
(43) Pub. Date: Mar. 31, 2005

(54) METHOD FOR ENABLING A BRANCH-CONTROL SYSTEM IN A MICROCOMPUTER APPARATUS

(76) Inventor: Yao-Huang Hsieh, Hsin-Chu Hsien (TW)

Correspondence Address: (NAIPC) NORTH AMERICA INTERNATIONAL PATENT OFFICE, P.O. BOX 506, MERRIFIELD, VA, 22116, US

(21) Appl. No.: 10/605,418

(22) Filed: Sep. 30, 2003

(51) Int. Cl. G06F 15/00; G06F 9/44; G06F 9/00; G06F 7/38

(52) U.S. Cl. 712/226; 712/233

(57) ABSTRACT

According to the claimed invention, the controller is a chip with a memory connected to the program counter of a microcomputer apparatus. The chip is capable of comparing the value of the program counter against the value stored inside its own memory and issuing an indirect branch instruction with an index upon a match. The indirect branch instruction is capable of searching a table for an entry corresponding to the index and replacing the value of the program counter with the value of the entry in the table.

### BACKGROUND OF INVENTION

1. Field of the Invention

The invention relates to a branch-control system for a microcomputer apparatus and more particularly, to a branch-control system for a ROM-programmed microcomputer apparatus.

2. Description of the Prior Art

Microcomputer apparatuses are ubiquitous in today's world. Found in everything from cellular phones to DVD players, most electronic devices posses some form of a microcomputer apparatus in the form of a processing unit executing instructions stored in memory. In addition, almost all of these microcomputer apparatuses have a processor executable program stored in a ROM-type memory and hence, can be considered a ROM-programmed processing unit (ROM-programmed processing unit can be considered as any processing unit that executes instructions stored in a ROM Read Only Memory).

A main function of a processing unit of the microcomputer apparatus is to execute instructions. An important consequence of this fact is that a processing unit is unable to track its progress through a program. In order to enable a processing unit to go from instruction to instruction in a program, a program counter is coupled to the processing unit. The program counter facilitates movement by storing a program count value and changing the program count value whenever an instruction is decoded. The program count value refers to the next instruction that needs to be executed. For example, if the program count value is 1, then the first instruction needs to be fetched; if the program count value is 2, then the second instruction needs to be fetched; if the program count value is 3, then the third instruction needs to be fetched; and so on. In this manner, the processing unit is able to go through each instruction in a program.

Although there is more than one type of ROM, the masked ROM is most often used when a device is mass-produced. Compared to other types of ROM, the masked ROM is the cheapest to use in mass production. However, the masked ROM suffers one major drawback: the masked ROM can only be written to once. As a result, any changes that need to be made after the masked ROM has been programmed cannot be made.

Despite careful testing and debugging, there are times when the code in the ROM needs to be altered after the ROM has been programmed-usually because some erroneous sections of code are found. However, for reasons stated above, the code inside of a written masked ROM cannot be changed. One approach to the problem is to have the processing unit go to another memory and execute a patch for each section of unwanted instructions in the masked ROM (A patch is defined as a group of replacement instruction lines). For example, imagine there is a ROM that has 200 instruction lines addressed by the program count values 0-199. The ROM contains errors at lines 35-40, lines 125-130, and lines 151-160. Since there are three sections of unwanted code, then three patches are needed.

U.S. Pat. No. 4,542,453 Patrick et al and U.S. Pat. No. 5,581,776-Hagqvist et al. of the prior art disclose devices on how to employ such a solution.

Please refer to FIG. 1. FIG. 1 is a diagram of a microcomputer apparatus 10 according to U.S. Pat. No. 4,542,453—Patrick et al. The microcomputer apparatus 10 comprises a ROM 12, a processing unit 14, a program counter 16, an interrupt controller 18, and a program patching module 20. The program patching module 20 comprises a patch memory 22, a chip selector 24, and a marker bit memory 26.

To branch off the ROM 16, the first prior art employs a program patching module 20. The marker bit memory 26 of the program patching module 20 is connected to the program counter 16 and stores one bit for every instruction contained in the ROM 12. These bits are named marker bits because they mark whether a branch is to occur or not. As the program counter 16 goes through count values, the program patching module 20 checks the corresponding marker bit. If the marker bit is 0, nothing happens and the next instruction on the ROM 16 is fetched. However, if the marker bit is 1, the marker bit memory sends a signal to the interrupt controller 18 to interrupt the processor unit 14. The interrupted processing unit 14 then changes the value in the program counter 16. The new value in the program counter 16 is then detected by the chip selector 24, which in response switches the processing unit 14 onto the patch memory 22 to execute the stored patches.

Please refer to FIG. 2. FIG. 2 is a diagram of microcomputer apparatus 30 according to U.S. Pat. No. 5,581,776 Hagqvist et al. The microcomputer apparatus 30 comprises a ROM 32, a processing unit 34, a program counter 36, an auxiliary memory 38, an address comparator 40 that has a register 42, and a branch register 44.

In the second prior art, the address comparator 40 and the branch register 44 are used in tandem to accomplish a branch off the ROM 32. An initializing value corresponding to a program count value in the ROM 32 where the branch is to begin is stored in the address comparator 40 while a replacement value corresponding to the program count value of the first instruction in the applied patch is stored in the branch register 44. The two values and their respective parts work together to accomplish one patch. Each time the program counter 36 issues a program count value, the address comparator 40 compares the issued program count value against the initializing value stored in its register 42. Once a match is detected, the replacement value stored in the branch register 44 is downloaded into the program counter 36, replacing the program count value that caused the match. As a result, the processing unit 34 will branch off the ROM 32 and execute a patch located on an auxiliary memory 38.

The prior art accomplishes the task of having the processing unit run a patch in lieu of a section of unwanted code in a ROM but not without disadvantages. The first prior art has too much overhead i.e. one marker bit has to be stored for each instruction in the ROM 12. If the program in the ROM 12 is very small, this may not be much of a disadvantage. However, as the size of the program in the ROM 12 becomes larger, the size of the corresponding the marker bit memory 26 becomes larger too. A larger size means a larger silicon die is needed to manufacture the chip, which leads to increased production cost. Even if the marker bit memory 26 of the program patching module 20 were of small size, it is highly unlikely that one would need to branch off at every instruction in the ROM 12. Consequently, many of the marker bits would be of a value of 0 and therefore, wasted.

The first prior art further suffers from the use of a chip selector 24 and the interrupt controller 18. The chip selector 24 is simply an additional hardware cost incurred by the prior art. The use of the interrupt controller 18 lengthens the time necessary to cause the microcomputer apparatus 10 to branch off the ROM 12 and onto the patch memory 22.

The second prior art is an improvement in that only the initializing values that will cause a branch are stored instead of storing a marker bit for every instruction. However, the improvement in size is offset by the use of extra hardware not present in the first art, namely the branch register 44. As a result, even though space and chip size have been reduced by only storing initializing values, the savings are negated by the use of an extra chip the branch register 44. In the end, this solution faces similar problems as the first prior art in that production costs are higher because of the increase in the chip die size.

### SUMMARY OF INVENTION

It is therefore a primary objective of the claimed invention to provide microprocessor apparatus having a controller capable of sending indirect branch instructions used in conjunction with a table located in an auxiliary memory to solve the above-mentioned problem.

According to the claimed invention, a microprocessor apparatus is disclosed. The microprocessor apparatus comprises a program counter for storing a program count value; a processing unit coupled to the program counter; a read only memory coupled to the processing unit for storing a first program; an auxiliary programmable-memory coupled to the processing unit for storing patches to replace corresponding instructions in the first program along with a table containing a replacement program count value for each patch; and a controller coupled to the program counter and the processing unit for passing an indirect branch instruction corresponding to one of the patches to the processing unit in response to a match between the program count value and an initializing program count value, wherein the indirect branch instruction will insert the replacement program count value corresponding to the match into the program counter. The aforementioned processing unit comprises an instruction fetching means coupled to the program counter for reading program instructions according to the program count value and storing fetched instructions in a buffer and an instruction decoding means coupled to the instruction fetching means for decoding and dispatching buffered instructions for execution.

It is advantageous of the present invention microprocessor apparatus to employ a controller having a register for storing an initializing program count value and an auxiliary memory for storing patches along with a table contained a replacement program count value for each patch. By using the controller and auxiliary memory, the present invention can reduce the amount of hardware necessary to implement a branch off the ROM and in some cases, the amount of time needed to make a branch. In turn, production costs can be lowered.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a microcomputer apparatus according to the first prior art.

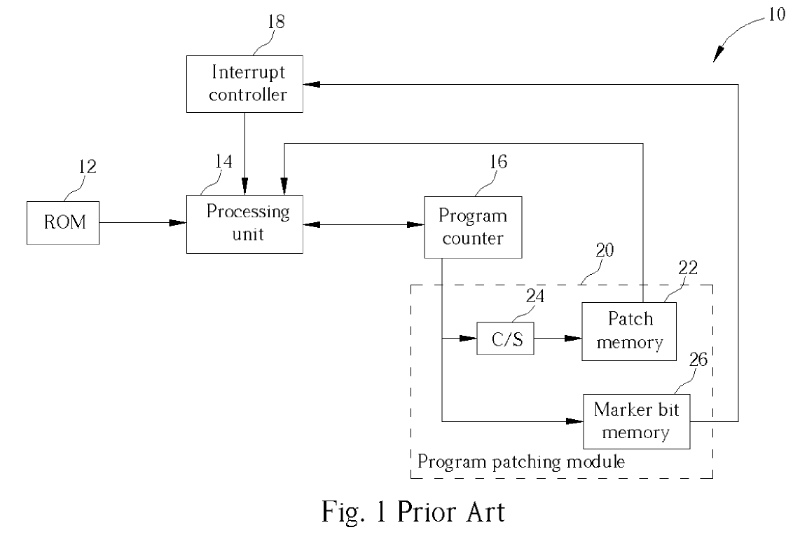

FIG. 2 is a diagram of a microcomputer apparatus according to the second prior art.

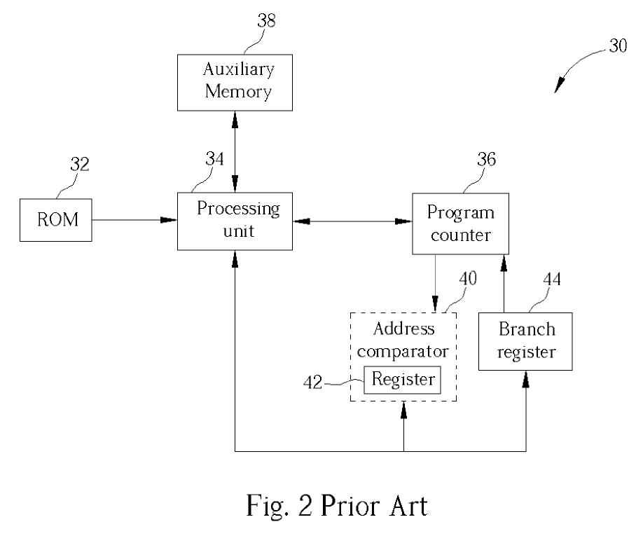

FIG. 3 is a diagram of a microcomputer apparatus according to the present invention.

FIG. 4 is a flowchart of the method used in a microcomputer apparatus according to the present invention.

### DETAILED DESCRIPTION

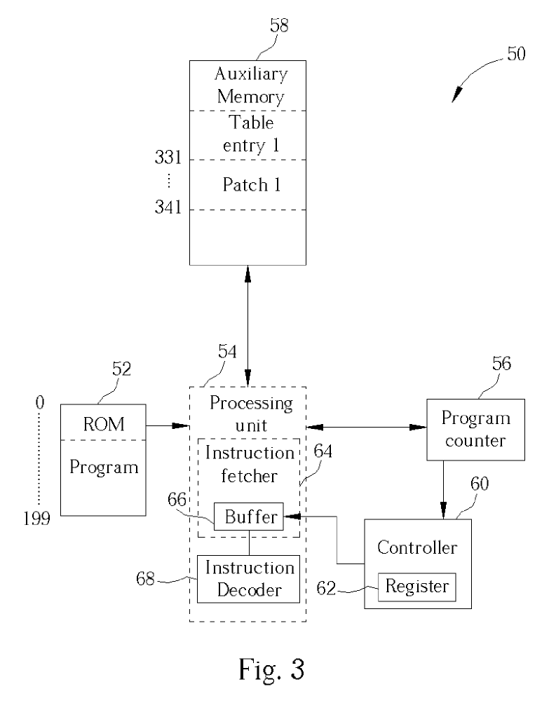

Please refer to FIG. 3. FIG. 3 shows a diagram of a microcomputer apparatus 50 according to the present invention. The microcomputer apparatus 50 comprises a ROM 52 for storing a first program, a processing unit 54 for executing instructions, a program counter 56 for storing a program count value, an auxiliary memory 58 for storing patches and a table of corresponding replacement count values, and a controller 60 for storing and comparing an initializing count value to the program counter's 56 count value and issuing an indirect branch instruction with an index in response to a match.

In a preferred embodiment, the processing unit 54 comprises an instruction fetcher 64 that has a buffer 66 and an instruction decoder 68. The instruction fetcher 64 retrieves instructions according to the program counter 56 and stores instructions in the buffer 66. The instruction decoder 68 increments the program counter 56 and decodes instructions stored in the buffer 66. The controller 62 comprises a register 62 for storing an initializing program count value that, upon a match with the value stored in program counter 56, will cause the controller 62 to issue an indirect branch instruction.

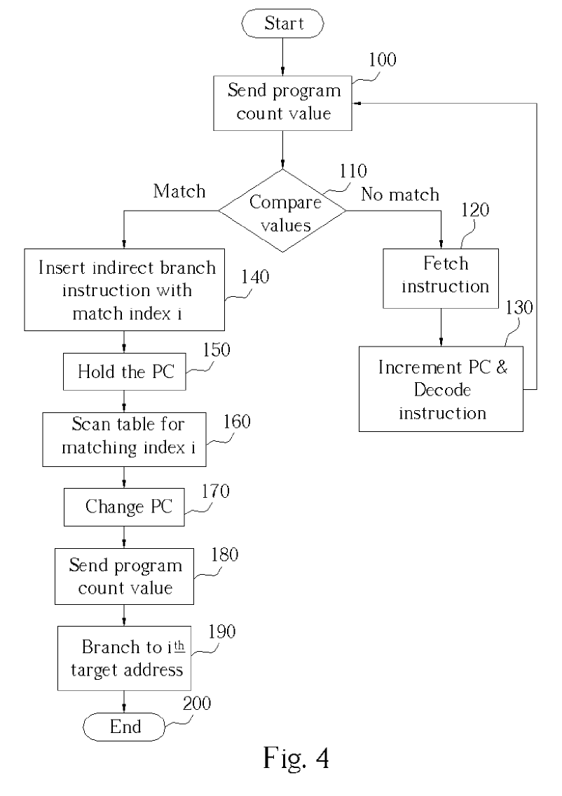

Please refer to FIG. 3 and FIG. 4. FIG. 4 is a flowchart of the method used by the microcomputer apparatus 50 according to the present invention. The steps are detailed in the following.

100: The program counter 56 sends a program count value to the processing unit 54 and the controller 60.

110: The controller 60 compares the sent program count value against an initializing program count value stored in the register 62 of the controller 60. If there is no match, enter step 120. Otherwise, enter step 140.

120: The instruction fetcher 64 fetches an instruction from the ROM 52 and places the instruction in the buffer 66 of the instruction fetcher 64.

130: The instruction decoder 68 increments the program count value in the program counter 56 by 1 and decodes the instruction stored in buffer 66. Return to step 100.

140: The controller 60 inserts an indirect branch instruction with a matching index into the buffer 66.

150: The instruction decoder 68 holds the program count value in the program counter 56.

160: The processing unit 54 scans the table located in auxiliary memory 58 for a table entry with the matching index i.

170: The processing unit 54 changes the program count value in the program counter 56 to a replacement program count value found in the table entry with the matching index i.

180: The program counter 56 sends this replacement program count value to the processing unit 54.

190: The processing unit 54 branches to the i^{th} target address.

200: End of method.

Please refer back to only FIG. 3 for the following detailed instruction. As previously mentioned, the function of the program counter 56 is to track the progress of the processing unit 54 through a program. The program counter 56 stores a program count value, which represents the instruction that the instruction fetcher 64 needs to fetch. Whenever the instruction decoder 68 finishes decoding an instruction, it increments the program count value in the program counter 56 by one. In this way, the processing unit 54 is able to go through a program.

For example, imagine a program with 200 instructions (program count values 0-199) is being executed. At the start of the program, the program counter 56 issues a program count value of 0 to the instruction fetcher 64. The instruction fetcher 64 then places Instruction 0 into the buffer 66. The instruction decoder 68 decodes the buffered Instruction 0 and increments the program count value in the program counter 56 by 1. Afterwards, the processing unit 54 executes Instruction 0 as the program counter 56 issues its new program count value of 1 to the instruction fetcher 64 to start the process again. The instruction fetcher 64 then places Instruction 1 into the buffer 66. The instruction decoder 68 then decodes Instruction 1 and increments the program count value in the program counter 56 by 1 so that the resulting value will be 2. After which, the processing unit 54 executes Instruction 1 while the program counter 56 starts the process anew. The same process loops repeatedly until the last program count value 199 is fetched.

In order to cause a processing unit 54 to branch off a first program stored in a ROM 52 and execute a patch located on another memory, the present embodiment of the invention employs a controller 60 along with patches and a table of corresponding replacement count values stored on an auxiliary memory 58. The controller 60 compares the program count value of the program counter 56 against an initializing value stored in the register 62 of the controller 60. The initializing value is the program count value of the first instruction of an unwanted section of code i.e. the first instruction in a section of unwanted code of the ROM 52 one wants to have replaced. Please note that the auxiliary memory 58 may be but not limited to Random Access-Memory RAM, flash memory, or even another ROM.

When the two values match, the controller 60 issues an indirect branch instruction attached with an index corresponding to the match into the buffer 66 of the instruction fetcher 64. Upon decoding the indirect branch instruction, the instruction decoder 68 will place the program counter 56 on hold instead of incrementing it by 1 like normally. The processing unit 54 will then execute the indirect branch instruction by using the attached index to search the table of replacement count values. Upon location of the proper table entry, the processing unit 54 will replace the program count value currently loaded in the program counter 56 with the replacement count value given by the table entry. Afterwards, the instruction fetcher 64 fetches the instruction referred to by the replacement count value. This referred to instruction is the first instruction of a patch located on an auxiliary memory 58.

The process of fetching, decoding, incrementing, and executing then proceeds on normally with the exception that the replacement count value is now being incremented after each cycle. Therefore, all count values hereafter refer to the instructions located on the auxiliary memory 58 and hence the patch. The program can end with the patch, or the processing unit 54 can be made to return to the ROM 52 after finishing the patch. The return back to the ROM 52 can be made by having the last line of the patch end with a terminating instruction branch. This terminating instruction branch is a branch instruction fixed to a program count value corresponding to the desired instruction of return on the ROM 52.

To make things clearer, imagine the ROM 52 has 200 instructions addressable with program count values 0-199. It is desired that a section of unwanted code lines 31-40 be replaced. Thus, the patch located on the auxiliary memory 58 would consist of replacement instructions 331-340 plus one additional instruction 341 to branch back to the ROM 52.

Starting from the beginning of the program, the program counter 56 has a program count value of 0. The program counter 56 issues a value of 0 to the two parts—the controller 60 and the instruction fetcher 64. The controller 60 compares the issued program count value to the initializing count value stored in the register 62 of the controller 60. In this case, the initializing count value is 31. Since 0 and 31 do not match, the controller 60 does nothing. The instruction fetcher 64 places Instruction 0 into the buffer 66. The instruction decoder 64 decodes Instruction 0 and increments the program count value in the program counter 56 by 1. Afterwards, the processing unit 54 executes Instruction 0 as the program counter 56 once again issues the new program count value, starting the process anew.

This loop continues until the program counter 56 issues a program count value of 31. This time when the controller 60 compares the two values, there is a match. In response, the controller 60 issues an indirect branch instruction containing an index into the buffer 66. Upon decoding this indirect branch instruction, the instruction decoder 68 pauses the program counter 56 instead of the normal incremental action. The processing unit 68 then executes the indirect branch instruction by using the contained index to scan a table located on an auxiliary memory 58.

Once found, the processing unit 54 loads the replacement count value of the table entry into the program counter 56. In this case, the replacement count value is 331. The program counter 56 then issues this value to the instruction fetcher 64. The instruction fetcher 64 then places the instruction 331 of the patch located on the auxiliary memory 58 into the buffer 22. The instruction decoder 68 then decodes this instruction and increments the program counter 56 by 1. The processing unit 54 executes the instruction as the program counter 56 issues 332 as the next program count value.

The process repeats until patch instruction 340 is executed. Since 340 is the last replacement instruction of the patch, patch instruction 341 is the terminating instruction branch. The terminating instruction branch is fixed to program count value 41. In this way, upon execution of the terminating instruction branch, the program counter 56 will be changed from 341 to 41. Then the processing unit 10 will branch back onto ROM 52 at instruction 41. In this way, the unwanted section of code-lines 31 40 have been skipped while other instructions were executed in its place.

Please note the following. For every branch off the ROM 52, one controller 60 with its own register 62 is needed. Therefore, if one would like to branch off the ROM 52 six times, then six controllers 60 are needed. Also note that the number of instructions in a section of unwanted code does not necessarily dictate the size of the patch to be used. For example, if a section of unwanted code is 10 instructions long (31-40), then patch to be used does not have to be ten instructions long as in the above example. The patch can be of variable length; it could be a single replacement instruction or 100 replacement instructions. Finally, branching back onto the ROM 52 is optional. The last instruction or instructions after the replacement instructions can be used as seen fit by the developer.

In contrast to the prior art, the present invention can implement a branching system using a controller 60 along with a table stored on an auxiliary memory 58 so that the amount of hardware and cost is minimal. As can be readily seen, only one controller 60 with one register 62 is needed to accomplish one branch. For comparison, assume a ROM has 512 instruction lines and we would like to implement one branch at instruction 31 and replace it with instruction 831 in a patch on some other memory.

In the preferred embodiment of the present invention described above, the controller 60 only needs 10 bits to store an initializing program count value of 31 to make the branch. In contrast, the marker bit memory 26 of the program patching module 20 in U.S. Pat. No. 4,542,453-Patrick et al. of the prior art needs 1024 bits to make the branch. Furthermore, by using an interrupt controller 18 to help the processing unit 14 to branch off, the prior art is inherently slower. In contrast to the other prior art, the invention in U.S. Pat. No. 5,581,776-Hagqvist et al needs 20 bits to accomplish the branch. 10 bits are needed by the register 42 of the address comparator 40 and the other 10 bits are needed by the branch register 44 to store their respective values. Furthermore, two modules are used in this prior art compared to one module in the present invention.

The number of bits needed in the above example was determined as follows. Computers read values in binary terms. The number of bits needed the address a certain amount of lines is determined by the exponent of 2 that provides a number equal to or greater than the amount of lines being addressed. In this case 2\hat{ }10 is equal to 1024, so 10 bits are needed. If 33 lines need to be addressed, then 6 bits would be needed since 2\hat{ }6 is equal to 64. 2\hat{ }5 would not be adequate since 2\hat{ }5 is equal to 32, meaning only 32 unique lines could be addressed.

As one can clearly see, by employing a table containing the replacement program count values stored on an auxiliary memory 58, the amount of hardware needed compared to the prior art is significantly less. In addition, when compared to certain prior art, a speed advantage in the time it takes to make a branch is also lessened.

Those skilled in the art will readily observe that numerous modifications and alterations of the device may be made while retaining the teachings of the invention. Accordingly, that above disclosure should be construed as limited only by the metes and bounds of the appended claims.

1. A microprocessor apparatus comprising:
a program counter for storing a program count value;
a processing unit coupled to the program counter comprising:
(a) an instruction fetching means coupled to the program counter for reading program instructions according to the program count value and storing fetched instructions in a buffer;
(b) an instruction decoding means coupled to the instruction fetching means for decoding and dispatching buffered instructions for execution;
a read only memory coupled to the processing unit for storing a first program;
an auxiliary programmable-memory coupled to the processing unit for storing patches to replace corresponding instructions in the first program along with a table containing a replacement program count value for each patch; and
a controller coupled to the program counter and the processing unit for passing an indirect branch instruction corresponding to one of the patches to the processing unit in response to a match between the program count value and an initializing program count value, wherein the indirect branch instruction will insert the replacement program count value corresponding to the match into the program counter.

2. The microprocessor apparatus in claim 1 wherein the controller further comprises:
a register for storing the initializing program count value.

3. A method for executing patch program segments in lieu of corresponding parts in a first program comprising:
(a) comparing a program count value of a program counter with an initializing program count value;
(b) inserting an indirect branch instruction with an index into a buffer of an instruction fetching means when a match is made in step (a);
(c) accessing a table in an auxiliary programmable memory according to the index of the indirect branch instruction; and
(d) changing the program count value of the program counter according to the table entry.

4. The method in claim 3 further comprising:
(e) ending the patch with a terminating instruction branch.

5. The method in claim 4 further comprising:
branching back to the first program in the read only memory with the terminating branch instruction.
